(19) United States
(12) Patent Application Publication
(10) Pub. No.: US 2007/0188825 A1
(43) Pub. Date: Aug. 16, 2007

(54) IMAGE READING APPARATUS

(75) Inventor: Takayuki Suga, Ibaraki-ken (JP)

Correspondence Address: BILL DRAINAS, P.O. BOX 3005, CROSSVILLE, TN, 38555, US

(73) Assignee: CANON KABUSHIKI KAISHA, Tokyo (JP)

(21) Appl. No.: 11/672,659

(22) Filed: Feb. 8, 2007

(30) Foreign Application Priority Data
Feb. 10, 2006 (JP) 2006-033453

(51) Int. Cl. H04N 1/04

(52) U.S. Cl. 358/474; 358/509

(57) ABSTRACT

An image reading apparatus includes an irradiation unit which includes a light source for irradiating an original; a reading unit which reads an image of the original at a reading line based on a reflected light from the original irradiated with the light source; and an adjusting unit for adjusting an angle between an irradiating line formed by the irradiation unit and the reading line.

### BACKGROUND OF THE INVENTION

1. Field of the Invention

The present invention relates to an image reading apparatus which is used in a copying machine, a facsimile machine, and an image scanner.

2. Description of the Related Art

In the image reading apparatus, in scanning a surface of an original with an irradiation light source and a folded mirror optical system, reflected light is imaged on a photoelectric conversion element by a lens and converted into an electric signal. Conventionally, a halogen lamp, a xenon lamp, or a fluorescent lamp is used as the irradiation light source. However, recently the use of a light emitting diode (LED) becomes widespread from the viewpoint of electric power saving. LED emits a smaller amount of light flux compared with tubular light source such as the halogen lamp, the xenon lamp, and the fluorescent lamp. Therefore, in order to increase light intensity, it is necessary that the light emitted from LED be collected to enhance irradiation efficiency using a lens or a reflecting plate such that a narrower region can be irradiate d.

Japanese Patent Application Laid-open No. 9-266516 proposes an image reading apparatus as a means for increasing the light intensity, wherein a diffusion plate is provided between LED and the collective lens, the light emitted from LED is diffused by the diffusion plate, and then the light is collected on a neighbor of a reading position by the collective lens. Japanese Patent Application Laid-open No. 7-162600 discusses an original irradiation apparatus with a xenon lamp, wherein the xenon lamp is adjusted by rotating the xenon lamp about a tube axis such that a light quantity becomes the maximum at a reading position on an original base plate glass. Japanese Patent Application Laid-open No. 2001-159795 proposes an image scanning apparatus and an adjustment method thereof, wherein an irradiation system including a tubular light source and a reflecting plate is attached to one holder board and the holder board is movably provided in parallel with to a sub-scanning direction such that a light intensity peak of the irradiation system is aligned with a reading position.

However, there are the following problems in any apparatus disclosed above.

One of the problems is in that, when the light flux emitted from LED is collected by the lens, a shift of the irradiating line formed by an irradiation unit is generated with respect to the reading line formed by a photoelectric conversion element. The shift is caused by various errors. Examples of the error include accuracy error or assembly error on production, generated in members such as LED and the lens which constitute the irradiation unit, and positioning accuracy error generated between pitches of an LED array or a lens array. Additionally, in members constituting the reading unit or between the members, there are errors such as an error of an optical path through which the light diffused on the surface of the original is guided, a forming accuracy error or a positional error of the lens for imaging the light on the photoelectric conversion element, and a positional error or an inclination error of the photoelectric conversion element. When both the errors of the irradiation unit and reading unit overlap each other, the irradiating line is shifted from the reading line. Particularly, in the case of the LED array in which the plural LEDs are arrayed, it is necessary that LED be accurately arrayed one by one. When compared with the case in which the one tubular light source is used, there is a higher possibility that the irradiating line of the LED array is inclined relative to the reading line in a plane parallel to the surface of the original. Therefore, in the LED array, frequently the original is read at a lower-light-intensity portion to degrade image quality, and the light intensity fluctuates depending on a location in the main scanning direction.

Another problem is in that, in the LED array, because LED is individually broken down or degraded, it is necessary to individually exchange LEDs. In such cases, because a tolerance exists in the accuracy of the irradiation unit, a slight change in positional accuracy is generated to change the irradiating line before and after the LED exchange, which may influence on the image.

There is also a problem in a structure in which the light source is rotated about an optical axis or a holder base of the light source and reflecting plate is moved in parallel to the sub-scanning direction. When the rotating or moving structure is adopted in the light source, although the irradiating line can be adjusted in parallel to the reading line of the photoelectric conversion element, it is very difficult that an inclination angle is adjusted or corrected when the irradiating line is inclined in the plane parallel to the surface of the original.

### SUMMARY OF THE INVENTION

In view of the foregoing, an object of the invention is to provide an image reading apparatus in which the position of the irradiating line is accurately adjusted relative to the reading line with a simple structure.

In order to achieve the object, an image reading apparatus according to an aspect of the invention includes an irradiation unit which includes a light source for irradiating an original;

a reading unit which reads an image of the original at a reading line based on a reflected light from the original irradiated with the light source;

and an adjusting unit for adjusting an angle between an irradiating line formed by the irradiation unit and the reading line.

According to the image reading apparatus of the invention, when the relative position is shifted between the reading line and the irradiating line, because the angle formed between irradiating line and the reading line can be adjusted, the reading region on the surface of the original is irradiated with the light having the appropriate light quantity. Therefore, the good image can be formed.

### BRIEF DESCRIPTION OF THE DRAWINGS

FIG. 1 illustrates a configuration of a scanner which is of an image reading apparatus according to a first embodiment of the invention;

FIG. 2 illustrates configurations of an irradiation unit and a reading unit in a first movable block which is a main part of the scanner of the first embodiment;

FIG. 3 is a perspective view illustrating the first movable block of the first embodiment;

FIGS. 4A and 4B are a graph illustrating distribution performance of CCD output;

FIG. 5 illustrates a configuration according to a second embodiment;

FIG. 6 illustrates configurations of an irradiation unit and a reading unit in a movable frame which is a main part of the scanner of the second embodiment; and

FIG. 7 is a perspective view illustrating the first movable block of the first embodiment.

### DESCRIPTION OF THE EMBODIMENTS

An image reading apparatus according to an exemplary embodiment of the invention will be described in detail with reference to the drawings.

### First Embodiment

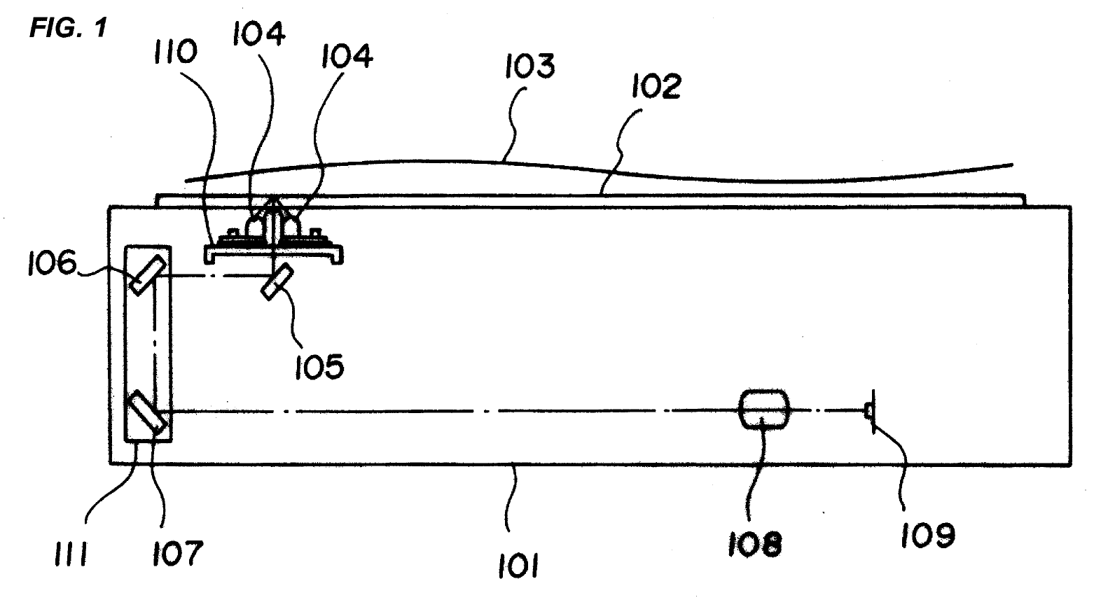

FIG. 1 illustrates an image reading apparatus (hereinafter referred to as “scanner”) 101 according to a first embodiment of the invention which is provided in an upper portion of a main body (not shown) of an image forming apparatus such as a copying machine. The scanner 101 includes the following members and devices. An original base plate 102 made of transparent glass is provided on a top portion of the scanner 101, and an original 103 to be read is placed on the original base plate 102. An optically-scanning reading unit is provided in the scanner main body, and the optically-scanning reading unit optically scans an image of the original 103 to image light reflected from the original 103.

The optically-scanning reading unit includes a first movable block 110 and a second movable block 111, which are moved in a sub-scanning direction by a drive mechanism (not shown). The first movable block 110 bears an irradiation unit 104 which irradiates the original 103 on the original base plate 102 with the light emitted from a light emitting diode (LED) 201 of the light source. The first movable block 110 also holds a reflecting mirror 105 which guides the light reflected and diffused on a surface of the original 103. The second movable block 111 holds reflecting mirrors (reflecting member) 106 and 107 which receive the light reflected from the reflecting mirror 105. The reflecting mirrors 105, 106, and 107 constitute a reading unit along with the following members and devices. The reading unit includes a lens (light collecting member) 108 and CCD (charge coupled device) 109. The lens 108 collects the light which is sequentially guided by the reflecting mirrors. CCD 109 performs photoelectric conversion to the light by imaging the reflected light image which is collected.

In the first embodiment, during the scanning, a moving speed of the first movable block 110 is set to be about double a moving speed of the second movable block 111. Accordingly, in scanning the original 103 to read image information, the irradiation unit 104 irradiates the original 103 with the light, and the original 103 is scanned while both the first movable block 110 and the second movable block 111 are moved. Because a scanning speed ratio of the first movable block 110 and the second movable block 111 is set to about 2:1, the scanning can be performed while an overall distance between the original 103 and CCD 109 is kept constant. The light with which the original 103 is irradiated is diffused on the surface of the original 103 and guided to the reading unit. After the light is sequentially guided to the reflecting mirrors 105, 106, and 107, the lens 108 collects the light to an imaging portion of CCD 109. The photoelectric conversion is performed to the light received by CCD 109. In the photoelectric conversion, an analog signal having a charge amount according to a light acceptance quantity is converted into a digital signal, and the digital signal is converted into image data which can be output as a visible image. Thus, the image information on the original 103 is read in the form of the electric signal.

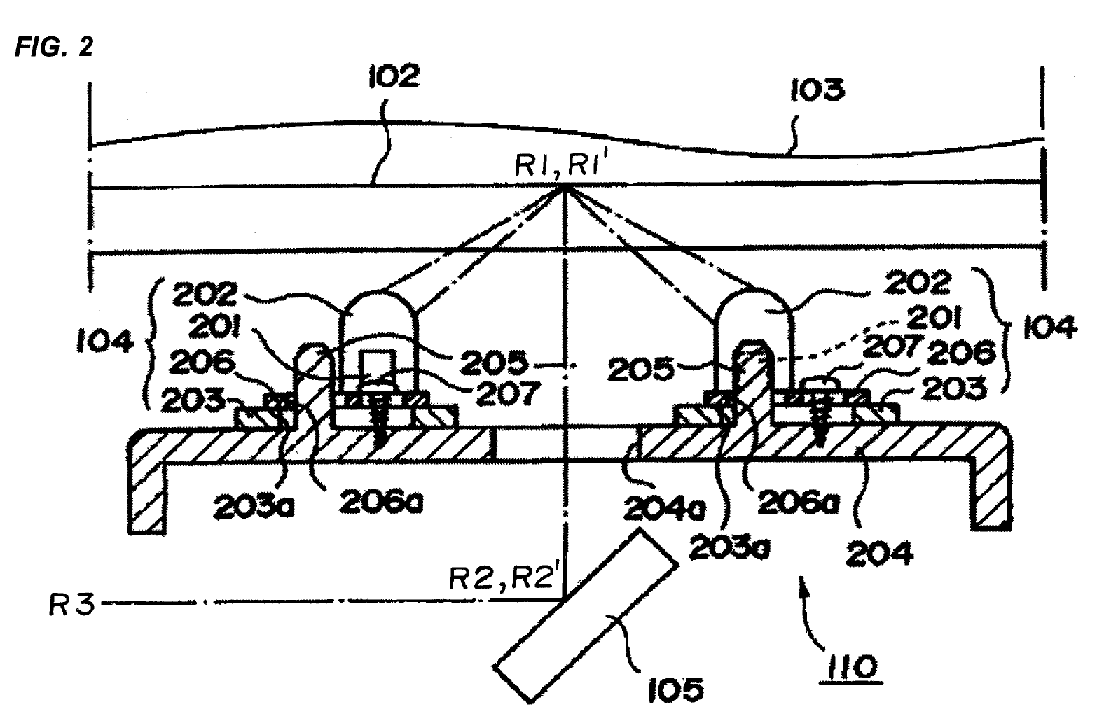

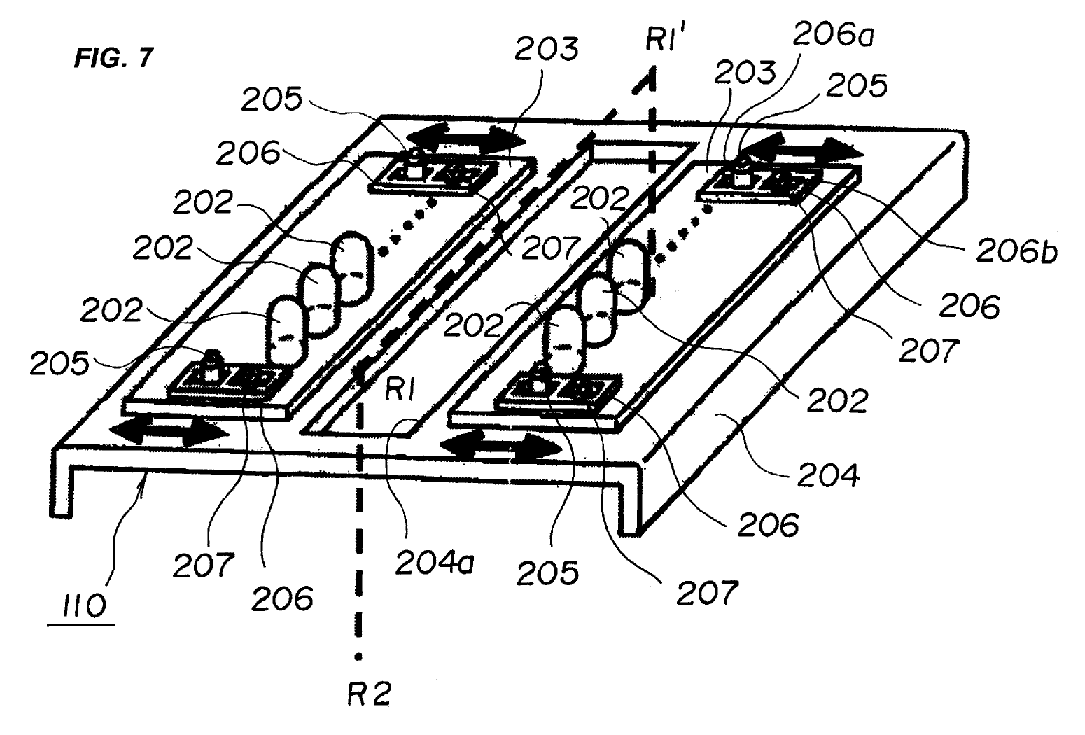

FIGS. 2, 3, and 7 show the first movable block 110 which bears the irradiation unit 104. The first movable block 110 includes a movable platform 204 which is formed in a long, flat plate shape in the main scanning direction of the reading, and is moved in the sub-scanning direction by the drive mechanism. The reflecting mirror 105 is provided in the movable platform 204. Light source holders (light-source holding members) 203 are placed on both sides of the movable platform 204, and the light source holders 203 are also formed in the long, flat plate shape in the main scanning direction. The irradiation unit 104 is provided on the light source holder 203, and includes LED 201 which is of an irradiation light source and a collective lens 202. The collective lens 202 which is of a light collecting unit collects the light such that a light intensity peak of part of the light emitted from LED 201 is located on a reading line (expressed by R1-R1′ in FIGS. 2 and 7) or close to the reading line. The optically-scanning reading unit reads the image of the original based on the light passing through a plane (hereinafter referred to as reading plane) surrounded by a broken line (R1-R1′-R2-R2′) in FIG. 7. The reading line on which the optically-scanning reading unit reads the image of the original is expressed by the line (R1-R1′) in which the reading plane and an upper surface of the original base plate 102 intersect each other.

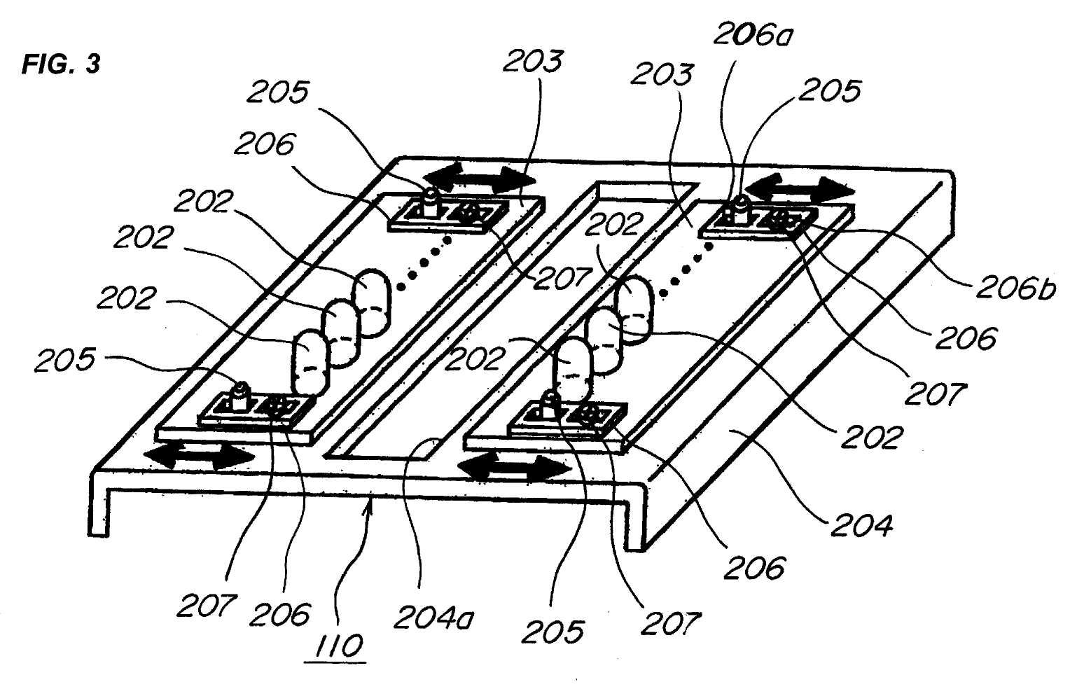

The collective lens 202 collects the light emitted from LED 201, a region to be read in the original 103 is irradiated with the light, and part of the diffused light passes through a light passing slit 204a which is provided in a central portion of the movable platform 204 while prolonged in the main scanning direction. The reflected light passing through the light passing slit 204a is guided to the reflecting mirror 105 along the reading plane R1-R2. The light reflected by reflecting mirror 105 is guided along the reading plane R2-R3. In the first embodiment, two rows of the irradiation units 104 including the LEDs 201 and collective lenses 202 are arrayed on the movable platform 204 through the light source holders 203 to form irradiating lines respectively (see FIG. 3). The irradiating lines on both the sides are joined together, and the region to be read of the original 103 is irradiated with the light from the irradiating lines.

Fine adjustment can separately be performed to positions of both sides of the light source holders 203 on the movable platform 204, and thereby fine adjustment can be performed to a position of the irradiating line formed by the irradiation unit 104. The irradiating line adjustment mechanism includes the following members.

As shown in FIG. 2, positioning pins (adjusting unit) 205 are vertically and integrally provided from upper surfaces of end portions in the main scanning direction of the movable platform 204 respectively. First long holes 203a through which the positioning pins 205 pierce are formed in end portions in longitudinal directions (main scanning directions) of the light source holders 203 respectively. Adjusters (adjusting unit) 206 are arranged on the end portions of the light source holders 203. In the adjuster 206, a second long hole 206a is formed on one end side of a small rectangular plate, and the positioning pin 205 pierces through both the second long hole 206a and the first long hole 203a of the light source holder 203. The other end side of the adjuster 206 is connected to the movable platform 204 while the light source holder 203 is pinched with a set-screw (adjusting unit) 207.

Accordingly, with the positioning pin 205 as a base-point axis, the light source holder 203 and the adjuster 206 can independently be moved on their end portions by hole lengths of the first long hole 203a and second long hole 206a in an arrow direction of FIG. 3 on the movable platform 204. The movements in the arrow directions of the adjuster 206 and light source holder 203 are the movement in the sub-scanning direction orthogonal to the main scanning direction. In addition to the movement in the sub-scanning direction, the light source holder 203 can also perform rotation-like motion about the positioning pin 205 as the base-point axis by independently adjusting the position of the adjusters 206 at end portions of the light source holder 203. The light source holder 203 is rotated in a plane parallel to the original base plate 102, or the light source holder 203 is rotated in the plane parallel to the original 103 when the original 103 is flat. Therefore, the light source holder 203 is adjusted at a position where the light source holder 203 is inclined at an angle relative to the main scanning direction, i.e., the reading line R1-R1′, so that the angle of the irradiating line can be adjusted by the irradiation unit 104.

Therefore, the irradiation unit 104 including the LED 201 and collective lens 202 is arrayed on the light source holder 203 which is long in the main scanning direction, and the irradiation units 104 are arranged on both the sides of the movable platform 204 to form the two rows of the irradiating lines. This allows the irradiation in the entire regions in the main scanning direction of the original 103. Additionally, the two rows of the irradiating lines are finely adjusted relative to the sub-scanning direction by the light source holder 203, and the angles of the irradiating lines are adjusted in the plane parallel to the original base plate 102. Therefore, the irradiating lines can accurately be aligned with the reading line R-R of the reading unit.

An operation in which the position of the irradiating line is adjusted with respect to the reading line R1-R1′ will specifically be described below. A white light diffusion member is placed on the original plate 102. LEDs 201 are lit on only in one of the two rows of the irradiation units 104 on the movable platform 204. CCD 109 generates charges according to the quantity of the acceptance light which is diffused on the surface of the original and guided to CCD 109. When the output of CCD 109 is measured, the position of the irradiating line can be detected relative to the reading line R1-R1′ which is associated with the reflecting mirrors 105 to 107, the lens 108 and CCD 109. When the position of the irradiating line is finely adjusted based on the above line position detection, the peak of a light intensity distribution can be aligned with an optical axis on the reading line R1-R1′.

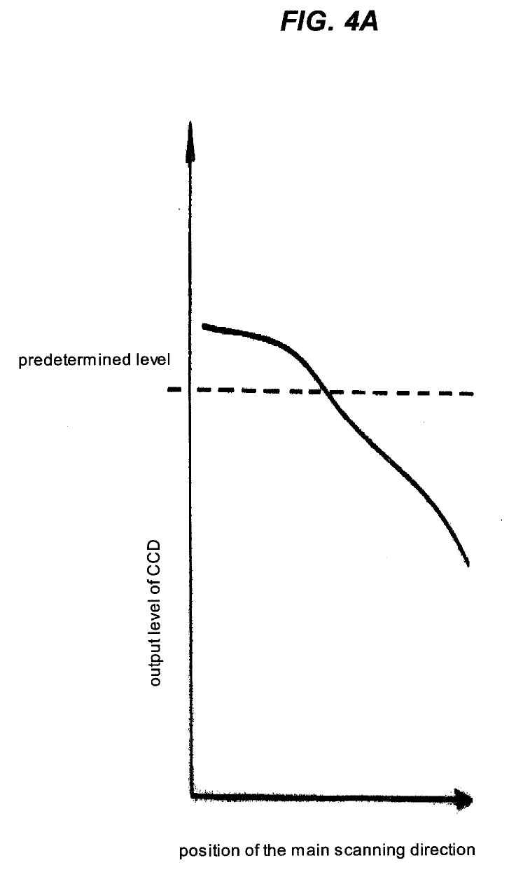

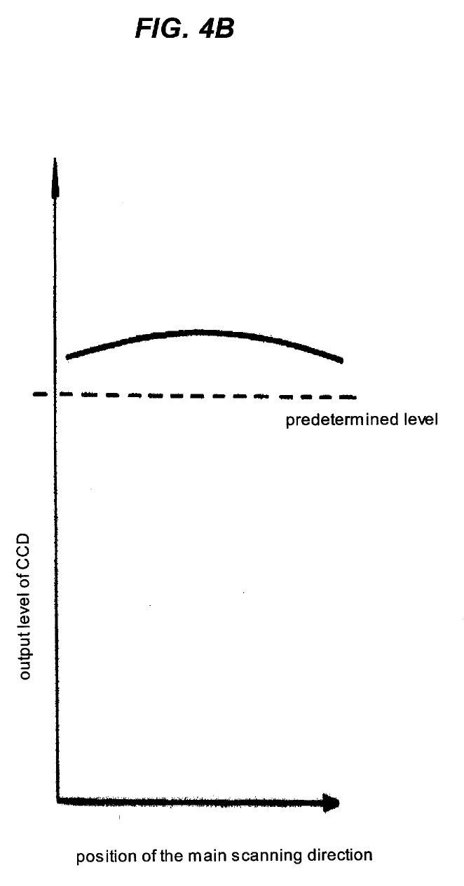

FIGS. 4A and 4B are a performance graph illustrating an output level of CCD 109 before and after the position of the irradiating line is adjusted with respect to the reading line R1-R1′. The position of the irradiation unit 104 which is lit on in two rows of the irradiating lines is adjusted in the sub-scanning direction such that the output of CCD 109 exhibits a value having a predetermined level or more while having a substantially symmetrical shape relation to the center of the main scanning direction. At this point, a swing angle generated by the rotation of the light source holder 203 is adjusted in the plane parallel to the original base plate 102 by the adjuster 206 while the positioning pin 205 is used as a supporting point. Then, the set-screw 207 is tightened to fix the light source holder 203 to the movable platform 204. After the position and angle of the light source holder 203 is adjusted, LEDs 201 of one irradiating line are turned off, and LEDs 201 of the other irradiating line are lit on to perform the same adjustment.

In the first embodiment, the collective lens 202 collects the light emitted from LED 201 of the irradiation unit 104 onto the reading line R1-R1′ or the neighbor of the reading line R1-R1′. Alternatively, a reflecting plate may be used in place of the collective lens 202. A structure of the reflecting plate will be described later in a second embodiment.

In the first embodiment, the two rows of the irradiation units 104 are symmetrically arrayed on both sides of the reading line R1-R1′. However, the invention is not limited to the two rows of the irradiation units arrayed on both sides of the reading line and these positions are independently adjusted. For example, the irradiation unit 104 may be arrayed only one side to form the irradiating line, or the two rows of the irradiation units 104 arrayed on both sides may simultaneously be moved while coupled by a single adjuster.

In the first embodiment, the small adjusters 206 are arranged on the end portions of the light source holder 203 which is long in the main scanning direction, and the positioning pin 205 is integrally projected from the upper surface of the movable platform 204. Alternatively, the positioning pin 205 may be formed so as to be movable on the movable platform 204. In this case, a fitting through-hole is made in the light source holder 203 in place of the first long hole 203a, and the movable positioning pin 205 is fitted in and pierces through the fitting through-hole. That is, the positioning pin 205 fitted in the fitting through-hole and the light source holder 203 may be configured so as to be integrally moved on the movable platform 204. The associated configuration therewith will be described later in the second embodiment.

In the first embodiment, the original is scanned while the scanning speed ratio of the first movable block 110 and the second movable block 111 is set to about 2:1. The invention is not limited to the structure in which the scanning speed ratio is set. As with the next second embodiment, the first movable block 110 and the second movable block 11 may be integrated into a frame-shape movable frame which integrally holds the irradiation unit and the reading unit.

The first embodiment obtains the following effect.

Both the irradiating lines on the movable platform 204 are merged to align the peak of the light intensity distribution with the reading line R-R. Therefore, even in the case of the narrow irradiating line in which the light flux emitted from LED 201 is collected by the collective lens 202, the irradiation can be realized with the appropriate light quantity in the entire region of the reading line R1-R1′.

### Second Embodiment

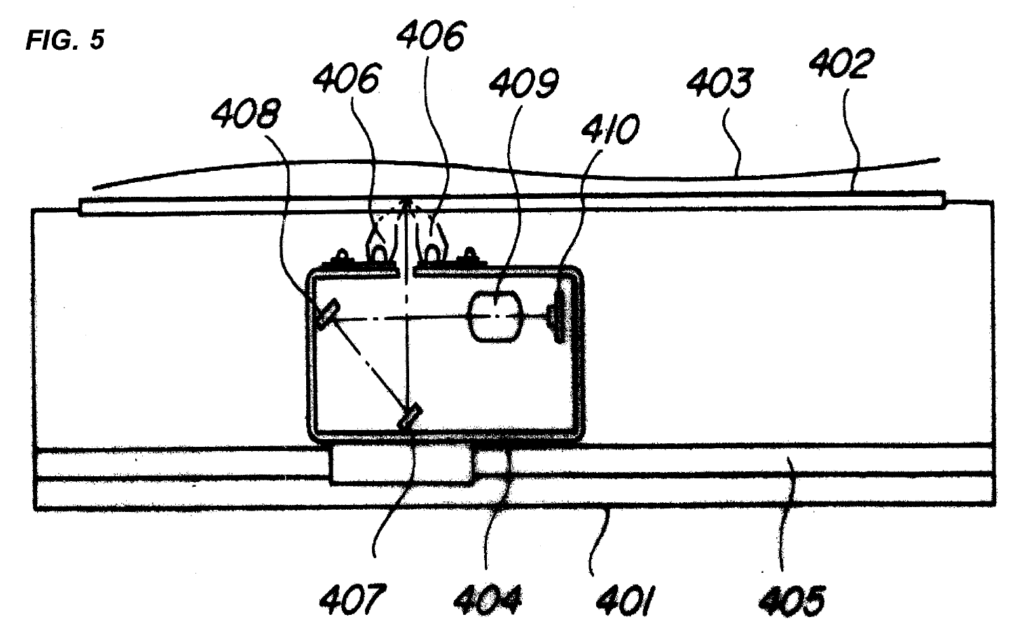

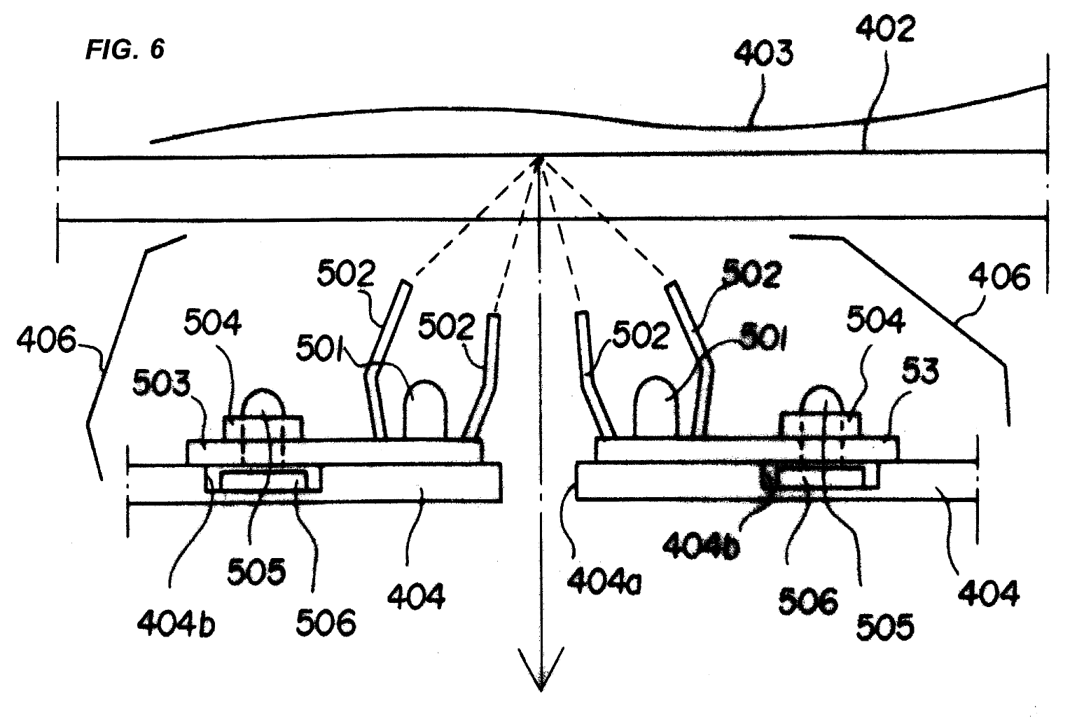

FIGS. 5 and 6 show a scanner 401 according to the second embodiment. In the first embodiment, the first movable block 110 and the second movable block 111 are independently formed, and the first movable block 110 differs from the second movable block 111 in the scanning speeds. In the second embodiment, a single movable frame 404 in which the first and second movable blocks 110 and 111 of the first embodiment are combined is provided in the main body of a scanner 401. The movable frame 404 is moved by a drive mechanism (not shown) while guided by a guide shaft 405. An irradiation unit 406 and a reading unit which includes reflecting mirrors 407 and 408, a lens 409, and CCD 410 are integrally held in the movable frame 404. The movable frame 404 scans an original 403 on an original base plate glass 402.

Accordingly, in reading the original 403 on the original base plate 402, the irradiation unit 406 irradiates the original 403 with the light, the reflecting mirrors 407 and 408 guide the light diffused from the surface of the original 403, and the lens 409 collects and images the light onto the light acceptance portion of CCD 410. CCD 410 performs the so-called photoelectric conversion in which CCD 410 converts the amount of charge accumulated according to the light acceptance quantity into the analog signal, and CCD 410 outputs the analog signal in the form of the image data which can be reproduced as the visible image by recording unit. Thus, the image information on the original 403 is read in the form of the electric signal.

The irradiation unit 406 on the movable frame 404 is formed by the following members shown in FIG. 6. The irradiation unit 406 includes light source holders 503 which are arranged on both sides of the movable frame 404 and are long in the main scanning direction such that the position of the irradiation unit 406 can be adjusted on the movable frame 404. In the movable frame 404, a recess 404b is formed in a region where the light source holder 503 is placed, and an adjuster base 506 having a flat shape movably engages the recess 404b within an area of the recess 404b. A positioning pin 505 is vertically projected from the adjuster base 506. The positioning pin 505 is fitted in a fitting hole made in the light source holder 503, and the positioning pin 505 is also fitted in and pierces through a fitting hole made in the adjuster 504. The adjuster 504 is fixedly connected to the movable frame 404 in each light source holder 503 by a set-screw (not shown), which allows the light source holder 503 to be positioned on the movable frame 404. Thus, as with the first embodiment, each position of the light source holders 503 on both sides is independently adjusted by the adjuster base 506, the positioning pin 505, and the adjuster 504. Accordingly, LEDs 501 which are of the light source are arrayed in the main scanning direction on the light source holders 503 on both sides, the light emitted from LEDs 501 is collected onto the reading line R or the neighbor of the reading line R by the reflecting plate 502. The irradiating line is formed by the irradiation unit 406.

In the second embodiment, the irradiating lines formed by the irradiation units 406 located on both sides are merged on the original base plate 402 such that the light intensity peak is aligned with the reading line R or the neighbor of the reading line R. The reflecting plates 502 are inclined at predetermined angles to merge the irradiating lines. A light passing hole 404a is pierced through the movable frame 404 between the irradiation units 406 on both sides. The light reflected from the surface of the original 403 passes through the light passing hole 404a, and the light is guided by the reflecting mirrors 407 and 408.

The positions of the light source holders 503 are adjusted as follows, in order to align the light intensity peak of the irradiating lines on both sides with the reading line or the neighbor of the reading line. In this case, the irradiating line of the light emitted from the irradiation unit 406 is detected. When the irradiating line is shifted from the reading line R, the position of the light source holder 503 is adjusted using the set-screw 505 which tightens both the adjuster 504 in the upper portion and the adjuster base 506 in the lower portion, thereby correcting the shift amount of irradiating line with respect to the reading line R. For example, the fitting holes for the positioning pins 505 are made in the adjusters 504, a straight line is set so as to connect the fitting holes at both ends in the longitudinal direction of the light source holder 503, and the straight line is used as an indication of the irradiating line. The adjustment is performed while the straight line is detected, which allows the shift between the irradiating line and the reading line R to be corrected. After the adjustment, the adjuster 504 and the adjuster base 506 are tightened by the set-screw, and thereby the light source holder 503 is fixedly positioned on the movable frame 404.

As with the first embodiment, the white light diffusion member is placed on the original base plate glass 402, and LEDs 501 are lit on only in one of both sides of the irradiation units 406. CCD 410 generates the charges according to the quantity of the acceptance light which is diffused on the surface of the original and guided to CCD 410. When the output of CCD 410 is measured, the position of the irradiation unit 406 can be detected relative to the reading line R-R which is formed by the reflecting mirrors 407 and 408, the lens 409 and CCD 410. After the adjustment, LEDs 501 in one of the irradiation units 406 are turned off, and LEDs 501 in the other one of the irradiation units 406 are lit on to similarly adjust the angle and position. Then, the light source holder 503 is fixed to the movable frame 404.

Accordingly, in the second embodiment, as with the first embodiment, the reading unit in which image quality is not changed before and after the components are exchanged in the irradiation unit 406 can be obtained when the shift caused by an error is hardly generated in the irradiation unit 406 or the reading unit. That is, the apparatus in which the image quality is not changed before and after the components are exchanged in the irradiation unit 406 is realized without improving forming accuracy and positional accuracy of the component, so that component cost can be kept low.

In the second embodiment, the inclined reflecting plate 502 is used to collect the light emitted from LEDs 501. However, obviously the light can also be collected with the collective lens 202 as described in the first embodiment. The original may be read with a contact image sensor in which the same-magnification lens array is used.

The positional adjustment of the irradiating line in the first and second embodiments is summarized as follows.

### First Embodiment

(1) The irradiating line shift caused by the error of the accuracy of each member in the irradiation unit 104 is corrected by moving the light source holder 203 in the sub-scanning direction of the movable platform 204 to adjust the position within the long groove 206a of the adjuster 206.

### Second Embodiment

(1) The irradiating line shift caused by the error of the accuracy of each member in the irradiation unit 406 is corrected by moving the light source holder 503 in the sub-scanning direction along with the positioning pin 505, fitted in the light source holder 503, on the adjuster base 506 to adjust the position in the recess 404b of the movable frame 404.

(2) When the light flux emitted from LED 501 is collected to form the irradiating line by the reflecting plate 502, even if the formed irradiating line becomes narrowed, the irradiation can be realized with the appropriate light quantity in the entire region of the reading line.

Thus, the image reading apparatus according to the invention is described with respect to the scanners 101 and 401 of the first and second embodiments. However, the invention is not limited to the above embodiment, another embodiment, applications and modifications and combinations thereof could be also made without departing from the scope and spirit of the invention.

This application claims the benefit of priority from the prior Japanese Patent Application No. 2006-033453 filed on Feb. 10, 2006 the entire contents of which are incorporated by reference herein.

What is claimed is:

1. An image reading apparatus comprising:
an irradiation unit which includes a light source for irradiating an original; and
a reading unit which reads an image of the original at a reading line based on a reflected light from the original irradiated with the light source,
an adjusting unit for adjusting an angle between an irradiating line formed by the irradiation unit and the reading line.

2. The image reading apparatus according to claim 1, wherein the reading unit includes an optically-scanning reading unit which is moved in a sub-scanning direction, the sub-scanning direction intersecting the irradiating line of the irradiation unit,
the image reading apparatus further comprising:
an original base plate on which the original is placed, the irradiation unit irradiating the original with the light; and
a light-source holding member which holds the irradiation units in which a plurality of the light sources is arrayed along the irradiating line and are provided in the optically-scanning reading unit while a position of the light-source holding member is adjustable,
wherein the adjusting unit adjusts a rotation angle position of the light-source holding member within a plane parallel to the original base plate while adjusting a position of the light-source holding member in the sub-scanning direction on the optically-scanning reading unit.

3. The image reading apparatus according to claim 2, wherein the optically-scanning reading unit includes:
a first movable block which is moved in the sub-scanning direction while holding the irradiation unit; and
a second movable block which bears a reflecting member which reflects the light to be moved in the sub-scanning direction at a moving speed slower than a moving speed of the first movable block.

4. The image reading apparatus according to claim 3, wherein two of the irradiating lines can be formed by arranging two of the light-source holding members in parallel on the first movable block.

5. The image reading apparatus according to claim 2, wherein the adjusting unit is provided in both end portions in a direction of the irradiating line of the light-source holding member to independently position one end portion and the other end portion of the light-source holding member.

6. The image reading apparatus according to claim 3, wherein the adjusting unit includes:
positioning pins which are respectively provided in both end portions in a direction of the irradiating line of a movable platform constituting the first movable block;
the light-source holding member which has a first long hole, the positioning pin piercing through the first long hole;
an adjuster which has a second long hole through which the positioning pin pierces, and which is placed in each of both end portion in a main scanning direction of the light-source holding member; and
a set-screw which tightens and positions the light-source holding member and the adjuster in the movable platform, after positions of the light-source holding member and the adjuster are adjusted by moving the light-source holding member and the adjuster within a ranges of the first and second long holes while the positioning pin is set at a base point.

7. The image reading apparatus according to claim 1, wherein the light source is a plurality of LEDs.
